(19) United States
(12) Patent Application Publication
(10) Pub. No.: US 2012/0143592 A1
(43) Pub. Date: Jun. 7, 2012

(54) PREDETERMINED CODE TRANSMISSION FOR LANGUAGE INTERPRETATION

(76) Inventors: James L. Moore, JR., Carmel, CA (US); Louis F. Provenzano, JR., Monterey, CA (US)

(21) Appl. No.: 12/961,210

(22) Filed: Dec. 6, 2010

(51) Int. Cl. G06F 17/28

(52) U.S. Cl. 704/2

(57) ABSTRACT

An input is received with a communication device. The input has a predetermined code that initiates a communication through the communication device. Further, the predetermined code is transmitted from the communication device to a telecom carrier device. The telecom carrier device recognizes the predetermined code and routes the communication from the communication device to a dedicated telephone number for a live language interpretation system associated with the predetermined code. The live language interpretation system provides a live language interpretation service through a language interpreter.

### BACKGROUND

1. Field

This disclosure generally relates to the field of language interpretation. More particularly, the disclosure relates to connecting a communication device to obtain language interpretation.

2. General Background

Recent developments in wireless technology have made advanced wireless phones and smart phones the preferred technology for businesses and consumers. Further, the language industry is currently estimated at generating approximately twelve billion dollars annually. The language industry continues to grow with the increasing demand for language interpretation. Language interpretation provides assistance to a variety of fields. For example, live language interpretation reduces the risk of errors resulting from language barriers in public safety for first responders for police, ambulance service, hospitals, and disaster relief efforts.

However, current approaches to providing live language interpretation services over wireless devices may be cumbersome for users. As an example, the user may have to be aware of a long telephone number to call to be connected to a live language interpreter through a language interpretation provider. In an emergency situation, that phone number may be too difficult to remember or find through a long list of contacts in a wireless device. The amount of time needed to find and dial a standard telephone number may simply be too long in an emergency situation.

Further, a user may receive a bill from the language interpretation provider in addition to a bill from the telecom carrier. Accordingly, the user may have to deal with multiple bills for the same telephone call.

### SUMMARY

In one aspect of the disclosure, a process is provided. The process receives, with a communication device, an input having a predetermined code that initiates a communication through the communication device. Further, the process transmits the predetermined code from the communication device to a telecom carrier device. The telecom carrier device recognizes the predetermined code and routes the communication from the communication device to a dedicated telephone number for a live language interpretation system associated with the predetermined code. The live language interpretation system provides a live language interpretation service through a language interpreter.

In another aspect of the disclosure, a communication device is provided. The communication device includes an input module that receives a predetermined code that initiates a communication through the communication device. Further, the communication device includes a transmission module, which is operated by a processor in the communication device that transmits the predetermined code from the communication device to a telecom carrier device. The telecom carrier device recognizes the predetermined code and routes the communication from the communication device to a dedicated telephone number for a live language interpretation system associated with the predetermined code. The live language interpretation system provides a live language interpretation service through a language interpreter.

In yet another aspect of the disclosure, a communication system is provided. The communication system includes a reception module that receives a predetermined code from a communication device. Further, the communication system includes a processor that recognizes the predetermined code. In addition, the communication system includes a routing module that routes the communication from the communication device to a dedicated telephone number for a live language interpretation system associated with the predetermined code, the live language interpretation system providing a live language interpretation service through a language interpreter.

In another aspect of the disclosure, a computer program product is provided. The computer program product comprises a computer useable medium having a computer readable program. The computer readable program when executed on a computer causes the computer to receive, with a communication device, an input having a predetermined code that initiates a communication through the communication device. Further, the computer readable program when executed on the computer causes the computer to transmit the predetermined code from the communication device to a telecom carrier device, the telecom carrier device recognizing the predetermined code and routing the communication from the communication device to a dedicated telephone number for a live language interpretation system associated with the predetermined code. The live language interpretation system provides a live language interpretation service through a language interpreter.

In yet another aspect of the disclosure, a computer program product is provided. The computer program product comprises a computer useable medium having a computer readable program. The computer readable program when executed on a computer causes the computer to receive a predetermined code from a communication device. Further, the computer readable program when executed on the computer causes the computer to recognize, with a processor, the predetermined code. In addition. Further, the computer readable program when executed on the computer causes the computer to route the communication from the communication device to a dedicated telephone number for a live language interpretation system associated with the predetermined code. The live language interpretation system provides a live language interpretation service through a language interpreter.

In another aspect of the disclosure, a process is provided. The process receives a predetermined code from a communication device. Further, the process recognizes, with a processor, the predetermined code. In addition, the process routes the communication from the communication device to a dedicated telephone number for a live language interpretation system associated with the predetermined code, the live language interpretation system providing a live language interpretation service through a language interpreter.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a language interpretation system.

FIG. 2 illustrates an external view of the communication device.

FIG. 3 illustrates a process that is utilized to obtain live language interpretation with a predetermined code.

FIG. 4 illustrates a process that provides a predetermined code for language interpretation.

FIG. 5 illustrates another process that provides a predetermined code for language interpretation.

FIG. 6 illustrates a block diagram of a system that provides predetermined code recognition.

### DETAILED DESCRIPTION

A method, computer program product, apparatus, and system are provided for a predetermined code for language interpretation. The predetermined code allows the user to quickly connect his or her communication device to a live language interpreter. In one embodiment, the predetermined code includes an identifier that indicates that the communication should be reviewed by a predetermined code recognition module. In one embodiment, the telecom carrier builds the predetermined code into its infrastructure. As a result, the telecom carrier can quickly determine a language interpretation platform that corresponds to the predetermined code and route the telephone call to that language interpretation platform. Further, the telecom carrier can keep track of all the calls made by a user to the language interpretation platform. As a result, the user can receive a single bill for both telephone usage and language interpretation services from the telecom carrier.

With respect to wireless devices, the network feature for direct access to live language interpretation can help improve response time in emergency situations. Dialing a full length telephone number may simply take too long in an emergency situation. Further, looking up the telephone number on the Internet in addition to dialing that telephone number may take even longer. The network feature for direct access to live language interpretation allows the user to quickly obtain live language interpretation. Further, in one embodiment, by having the predetermined code established in the network by the telecom carrier, the unrealistic occurrence of many users storing the telephone number in their electronic contact list on their communication devices is removed. In other words, many users are realistically not likely to store the full length telephone number of the language interpretation platform in their electronic contact list. Even for the users that do store the full length telephone number of the language interpretation platform in their electronic contact list, those users would likely have to search their contact list to find the language interpretation platform. The time involved in performing that search could also be simply too long. Accordingly, the network feature for direct access to live language interpretation services may help in emergency situations.

Further, Limited English Proficients (LEPs) may utilize the network feature for direct access to live language interpretation. With the quick and instant access provided by the network feature for direct access to live language interpretation, LEPs may become more involved in their respective communities to help in emergency situations.

The live language interpreter is a neutral party. Further, in one embodiment, the communication involving the live language interpretation is confidential.

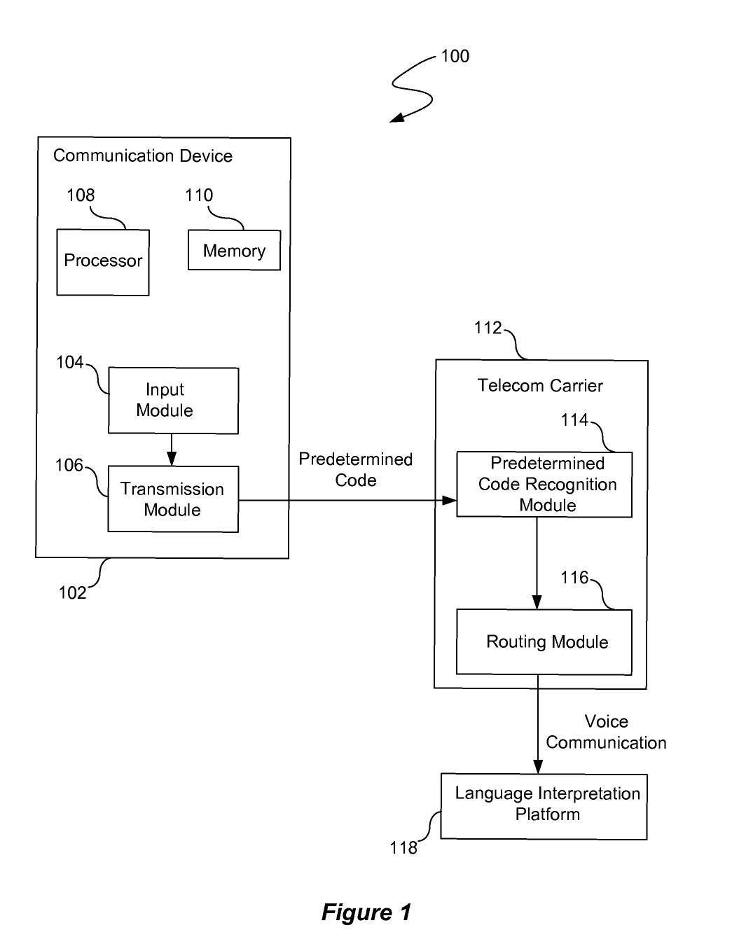

FIG. 1 illustrates a language interpretation system 100. The language interpretation system 100 includes a communication device 102, a telecom carrier 112, and a language interpretation platform 118.

The communication device 102 may be a smart phone, cell phone, personal digital assistant (“PDA”), wireless device, land line telephone, computer, dual handset landline device, dual handset wireless device, kiosk communication device, or any other apparatus that provides communication between at least one user and a live language interpreter. The communication device 102 may include a processor 108, a memory 110, an input module 104, and a transmission module 106. In an alternative embodiment, the communication device 102 may optionally not have the processor 108 and/or the memory 110. For example, a landline telephone may not have these components.

The user enters the predetermined code into the communication device 102. For example, the user may enter a predetermined code such as “*4” or “*L” into the communication device 102. The input module 104 receives the predetermined code and provides the predetermined code to the transmission module 106. The input module 104 may receive input through touch input, voice input, etc. The transmission module 106 then sends the predetermined code to the telecom carrier 112.

The telecom carrier 112 has a predetermined code recognition module 114 and a routing module 116. The predetermined code recognition module 114 determines a language interpretation platform associated with the predetermined code. As an example, the predetermined code recognition module may perform a database look up to determine which language interpretation platform is associated with the predetermined code. The predetermined code recognition module then provides information associated with the language interpretation platform 118 corresponding to the predetermined code to the routing module 116.

The routing module 116 then routes the voice communication to the language interpretation platform 118 corresponding to the predetermined code. In one embodiment, the language interpretation platform 118 provides a live language interpretation service to the user. In other words, the user may speak with a live language interpreter that provides language interpretation.

In one embodiment, the telecom carrier 112 tracks both the duration of the telephone call and the fees for the live language interpretation service. Accordingly, the telecom provider can provide a single bill to the user for both the telephone service and the language interpretation service.

In one embodiment, the predetermined code is significantly less in length than a standard telephone number. As an example, the predetermined code may include two characters such as a non-numeric indicia and a numeric indicia. In one embodiment, the non-numeric indicia may be the identifier that indicates that the voice communication should be send to the predetermined code recognition module. For example, the predetermined code of “*4” has a non-numeric indicia of “*” and a numeric indicia of “4.” The non-numeric indicia of “*” may be the indicator. Accordingly, the system of the telecom carrier will be aware that the voice communication should be sent to the predetermined code recognition module to determine what language interpretation platform corresponds with the predetermined code. Accordingly, the predetermined code may have an identifier portion and a non-identifier portion. Alternatively, the predetermined code may have as little as a single character. As an example, the predetermined code may be a non-numeric indicia. In other words, the predetermine code may simply have an identifier portion without a non-identifier portion. The identifier in any of the configurations provided for herein may be a non-numeric character, a numeric character, an alphabetic character, a non-alphabetic character, or the like. Further, the identifier may be more than one character. For example, the identifier may be a combination of different characters of the same type and/or different types of characters.

In one embodiment, the predetermined code corresponds to a dedicated telephone number. As an example, the predetermined code may correspond to a toll free telephone number. As another example, the predetermined code may correspond to a direct inward dialing (“DID”) telephone number. In another embodiment, the devices and equipment of the language interpretation system 100 are connected through a public switched telephone network (“PSTN”). In yet another embodiment, the devices and equipment of the language interpretation system 100 are connected through a digital communication network. In one configuration, the devices and equipment of the language interpretation system 100 are connected through the Internet, a local area network (“LAN”), a wide area network (“WAN”), wireless network, or the like.

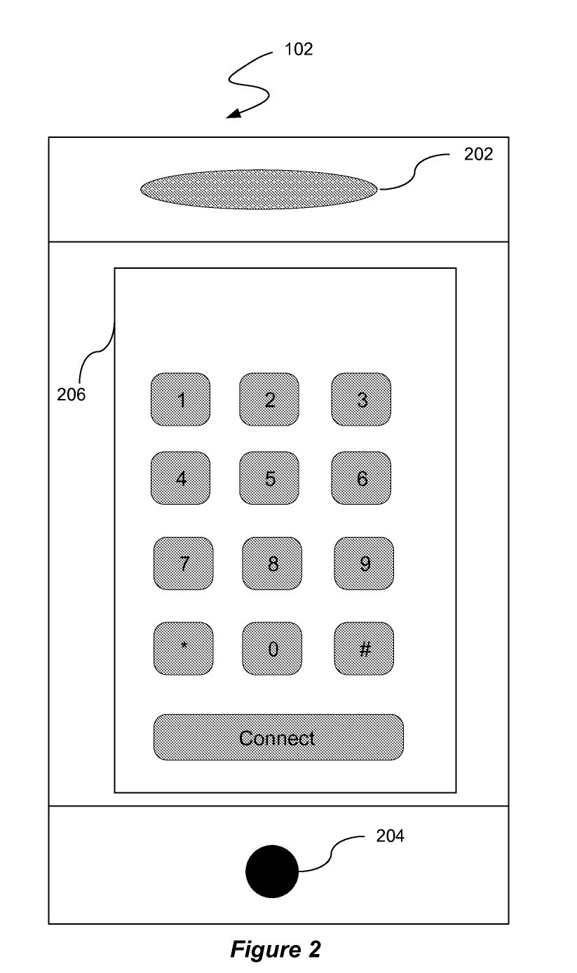

FIG. 2 illustrates an external view of the communication device 102. The communication device has a speaker 102 for inputting and outputting voice data. Further, the communication device 102 has a selector 204 that allows the user to make a selection to provide input. In addition, the communication device 102 has a display screen 206 that allows the user to visually interact with the Internet enabled communication device 102. The display screen 206 allows the user to navigate through the menus of an application and may prompt the user for information. In one embodiment, the display screen 206 has a plurality of input indicia that may be utilized to make a telephone call. For example, the plurality of input indicia may include numerals and non-numeric characters. Examples of the non-numeric characters include “*” and “#”. In another embodiment, the plurality of indicia may additionally or alternatively include alphabetic characters such as letters of the alphabet. In yet another embodiment, the plurality of input indicia is a plurality of actuators that is built into the communication device 102. For example, the plurality of input indicia may be a plurality of buttons.

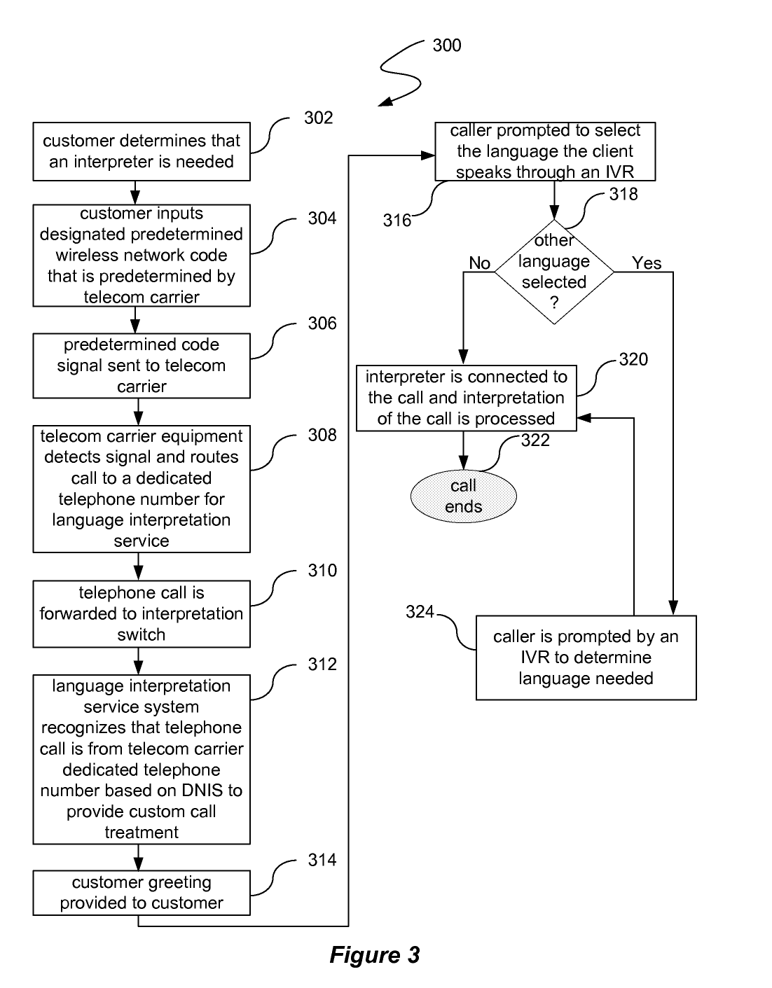

FIG. 3 illustrates a process 300 that is utilized to obtain live language interpretation with a predetermined code. At a process block 302, the process 300 has a customer determining that an interpreter is needed. Further, at a process block 304, the process 300 has a customer inputting a designated predetermined wireless network code that is predetermined by the telecom carrier. In other words, the predetermined code is determined by telecom carrier as the telecom carrier has to utilize its system to recognize the code and route the voice communication, e.g., telephone call, to the language interpretation platform. In addition, at a process block 306, the process 300 sends the predetermined code signal to the telecom carrier. At a process block 308, the telecom carrier equipment detects the predetermined code signal and routes the voice communication to a dedicated telephone number for language interpretation system. In one embodiment, the telecom carrier performs a database lookup to match the predetermined code to the language interpretation platform. Further, at a process block 310, the process 300 forwards the telephone call to the interpretation switch. In addition, at a process block 312, the process 300 recognizes, with a language interpretation system, that the telephone call is from a telecom carrier dedicated telephone number based on DNIS to provide custom call treatment. At a process block 314, the process 300 provides a customer greeting to the customer. Further, at a process block 316, the process 300 prompts the caller to select the language the client speaks through an interactive voice response (“IVR”) system. As an example, the user may be asked to enter “1” for Spanish and “2” for all other languages. At a decision block 318, the process 300 determines if another language has been selected. If another language has not been selected at the decision block 318, the process 300 advances to a process block 320 to connect an interpreter to the call. Interpretation of the call is processed. The process then advances to a process block 322 at which the call ends. If another language has been selected at the decision block 318, the process 300 advances to the process block 324 from the decision block 318. At the process block 324, the process 300 prompts the caller with an IVR to determine which of the other languages is needed. The process 300 then advances to the process block 320 to connect an interpreter to the call. Interpretation of the call is processed. The process 300 then advances to the process block 322 at which the call ends. The components of the process 300 are illustrated as examples of components that may be utilized. Accordingly, the process 300 may be utilized with less than all of the components and/or different components than those illustrated in FIG. 3. As an example, the process 300 may have an IVR that asks for the language the client speaks without any selection from different numerals. As yet another example, the process 300 may have an IVR that has a variety of different numerals for different selections.

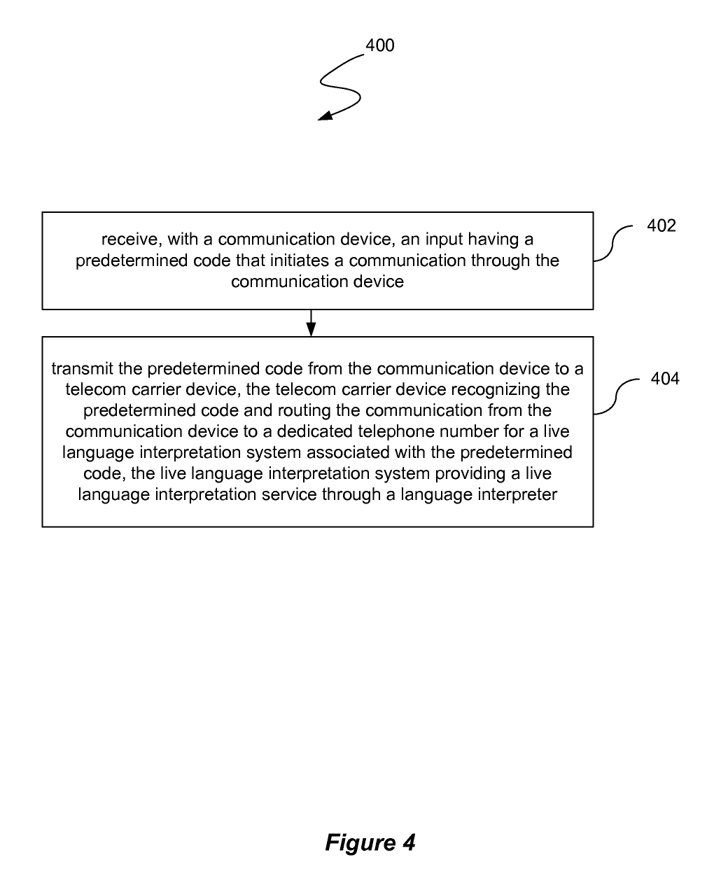

FIG. 4 illustrates a process 400 that provides a predetermined code for language interpretation. At a process bock 402, the process 400 receives, with a communication device, an input having a predetermined code that initiates a communication through the communication device. In one embodiment, the input is received by a user inputting the input indicia on the communication device. In another embodiment, the input is received by a user selecting the input indicia from a menu on the communication device. Further, at a process block 404, the process 400 transmits the predetermined code from the communication device 102 to a telecom carrier device. The telecom carrier device recognizes the predetermined code and routes the communication from the communication device to a dedicated telephone number for a live language interpretation system associated with the predetermined code. The live language interpretation system provides a live language interpretation service through a language interpreter.

In one embodiment, the live language interpretation system determines that the communication is from a telecom carrier dedicated number by utilizing Dialed Number Identification Service (“DNIS”). Further, the live language interpretation system may provide an automated greeting that includes a name of the telecom carrier. In another embodiment, the live language interpretation system provides a prompt for language to be interpreted. Further, the prompt is provided through an interactive voice response system.

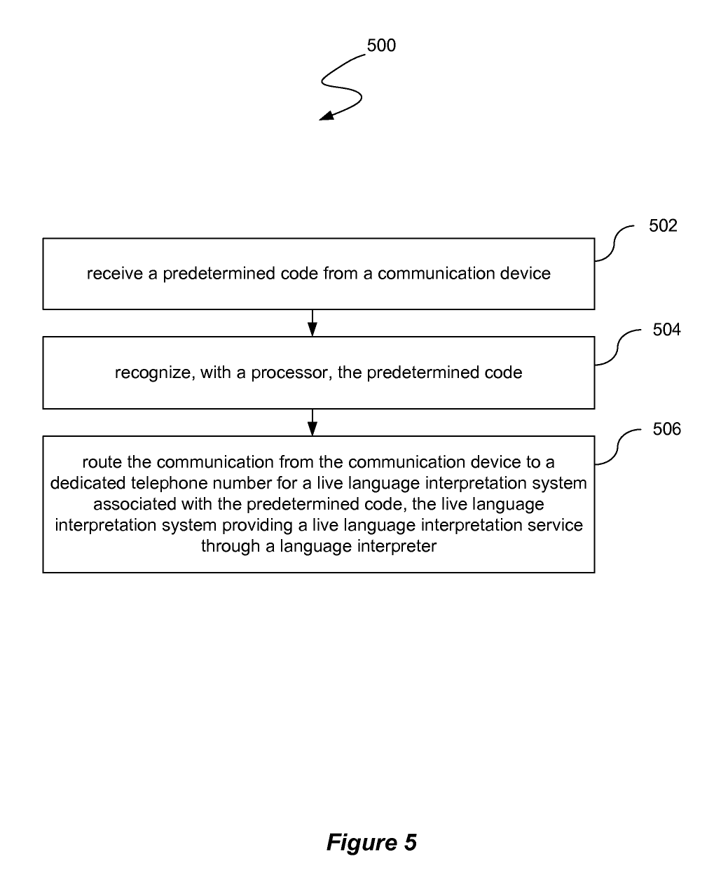

FIG. 5 illustrates another process 500 a predetermined code for language interpretation. At a process block 502, the process 500 receives a predetermined code from a communication device. Further, at a process block 504, the process 500 recognizes, with a processor, the predetermined code. In addition, at a process block 506, the process 500 routes the communication from the communication device to a dedicated telephone number for a live language interpretation system associated with the predetermined code. The live language interpretation system provides a live language interpretation service through a language interpreter.

In another embodiment, the predetermined code feature may be utilized at a kiosk in a retail location. For example, the telecom carrier may have a retail location for selling communication devices. An LEP may wish to purchase a communication device from the telecom provider at that retail location. The retail location may have a kiosk installed with the ability to offer language interpretation through the language interpretation platform. In one embodiment, the kiosk has a dual handset telephone system so that both the telecom carrier employee and the customer may connect to a live language interpreter to receive language interpretation between the telecom carrier employee and the customer. The network short code feature may be installed into the kiosk so that the telecom carrier employee or the LEP may dial the predetermined code be connected to a language interpreter. As an example, the telecom carrier employee may pick up one of the handsets and input the predetermined code to reach an interpreter. Further, the LEP picks up the other handset to join the call. With the dual handset system, the conversation is easier than the telecom carrier employee or the LEP having to exchange the same phone to hear the language interpreter.

In one embodiment, a caller may utilize a speakerphone capability of the communication device so that the caller and the other person speaking the other language can both talk to and hear the language interpreter. Alternatively, a three way conferencing mechanism may be utilized to connect the phone calls of the caller, the other person, and the language interpreter together.

In one embodiment, the telecom carrier has a billing system that computes both the telephone usage and language interpretation charges for the user so that the user receives a single bill from the telecom carrier. In contrast with the user receiving two bills for the telephone usage and the language interpretation charges, the telecom carrier allows the user to have the convenience of a single bill. The telecom carrier and the language interpretation provider can work out a financial arrangement so that the telecom carrier provides the language interpretation provider a fee for the language interpretation services.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of storing those instructions and include a CD-ROM, DVD, magnetic or other optical disc, tape, silicon memory, e.g., removable, non-removable, volatile or non-volatile, etc.

A computer is herein intended to include any device that has a general, multi-purpose or single purpose processor as described above. For example, a computer may be a set top box, cell phone, smart phone, portable media player, mp3 player, video player, or the like.

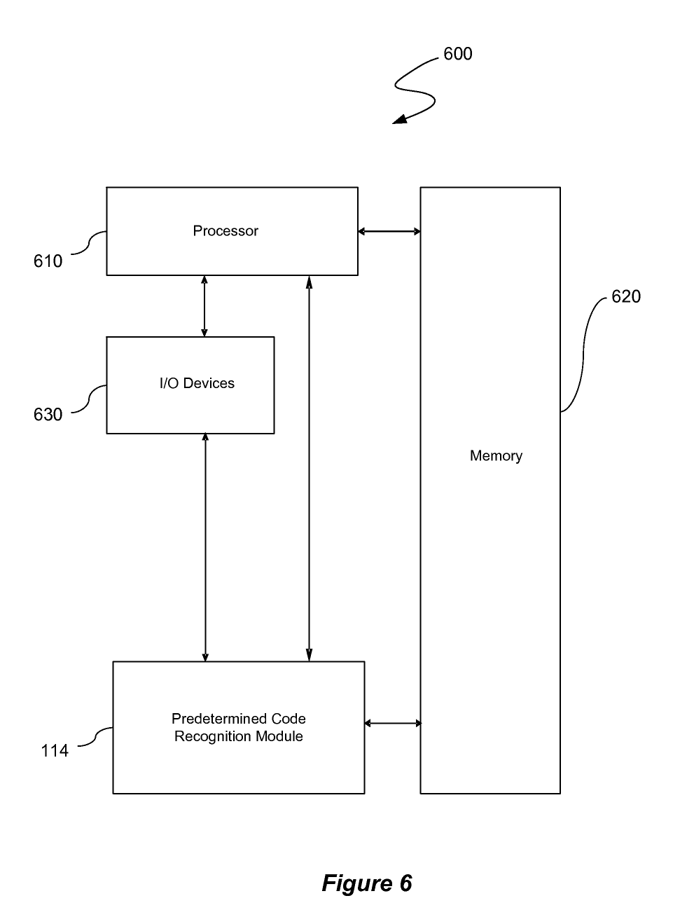

FIG. 6 illustrates a block diagram of a system 600 that provides predetermined code recognition. In one embodiment, the system 600 is implemented utilizing a general purpose computer or any other hardware equivalents. Thus, the system 600 comprises a processor 610, a memory 620, e.g., random access memory (“RAM”) and/or read only memory (ROM), the predetermined code recognition module 114, and various input/output devices 630, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the predetermined code recognition module 114 may be implemented as one or more physical devices that are coupled to the processor 610. Alternatively, the predetermined code recognition module 114 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 620 of the computer. As such, the predetermined code recognition module 114 (including associated data structures) of the present disclosure may be stored on a computer readable medium, e.g., RAM memory, magnetic or optical drive or diskette and the like. The system 600 may be utilized for a hardware implementation of any of the configurations provided herein.

The predetermined code configurations described herein may aid first responders in providing public safety and disaster relief, government agencies in providing airport security and patrolling the borders, healthcare providers in providing emergency care, delivery companies in providing shipments, etc. These configurations may assist small, medium, and large businesses in addition to government agencies and offices. As an example, police officers may utilize the predetermined code to quickly obtain live language interpretation from a confidential and neutral language interpreter to ensure effective and clear communication. Further, as another example, paramedics may quickly access an anonymous and neutral interpreter to obtain information that will help provide time critical medical care. The examples provided herein for the predetermined code are intended only as examples as the predetermined code may be utilized in a variety of different fields and contexts.

It is understood that the computer program products, apparatuses, systems, and processes described herein may also be applied in other types of apparatuses, systems, and processes. Those skilled in the art will appreciate that the various adaptations and modifications of the embodiments of the apparatuses, systems, and processes described herein may be configured without departing from the scope and spirit of the present computer program products, apparatuses, systems, and processes. Therefore, it is to be understood that, within the scope of the appended claims, the present computer program products, apparatuses, systems, and processes may be practiced other than as specifically described herein.

We claim:

1. A method comprising:
receiving, with a communication device, an input having a predetermined code that initiates a communication through the communication device; and
transmitting the predetermined code from the communication device to a telecom carrier device, the telecom carrier device recognizing the predetermined code and routing the communication from the communication device to a dedicated telephone number for a live language interpretation system associated with the predetermined code, the live language interpretation system providing a live language interpretation service through a language interpreter.

2. The method of claim 1, wherein the predetermined code includes a non-numeric character and a numeric character.

3. The method of claim 1, wherein the predetermined code includes a non-alphabetic character and a numeric character.

4. The method of claim 1, wherein the communication device is a cell phone.

5. The method of claim 1, wherein the communication device is a smart phone.

6. The method of claim 1, wherein the live language interpretation system determines that the communication is from a telecom carrier dedicated number by utilizing Dialed Number Identification Service.

7. The method of claim 6, wherein the live language interpretation system provides an automated greeting that includes a name of the telecom carrier.

8. The method of claim 1, wherein the live language interpretation system provides a prompt for language to be interpreted.

9. The method of claim 8, wherein the prompt is provided through an interactive voice response system.

10. A communication device comprising:
an input module that receives a predetermined code that initiates a communication through the communication device; and
a transmission module, which is operated by a processor in the communication device, that transmits the predetermined code from the communication device to a telecom carrier device, the telecom carrier device recognizing the predetermined code and routing the communication from the communication device to a dedicated telephone number for a live language interpretation system associated with the predetermined code, the live language interpretation system providing a live language interpretation service through a language interpreter.

11. The communication device of claim 10, wherein the predetermined code includes a non-numeric character and a numeric character.

12. The communication device of claim 10, wherein the predetermined code includes a non-alphabetic character and a numeric character.

13. The communication device of claim 10, wherein the live language interpretation system determines that the communication is from a telecom carrier dedicated number by utilizing Dialed Number Identification Service.

14. The communication device of claim 13, wherein the live language interpretation system provides an automated greeting that includes a name of the telecom carrier.

15. The communication device of claim 10, wherein the live language interpretation system provides a prompt for language to be interpreted.

16. The communication device of claim 15, wherein the prompt is provided through an interactive voice response system.

17. A communication system comprising:
a reception module that receives a predetermined code from a communication device;
a processor that recognizes the predetermined code; and
a routing module that routes the communication from the communication device to a dedicated telephone number for a live language interpretation system associated with the predetermined code, the live language interpretation system providing a live language interpretation service through a language interpreter.

18. The communication system of claim 17, wherein the predetermined code includes a non-numeric character and a numeric character.

19. The communication system of claim 17, wherein the predetermined code includes a non-alphabetic character and a numeric character.

20. The communication device of claim 17, wherein the live language interpretation system determines that the communication is from a telecom carrier dedicated number by utilizing Dialed Number Identification Service.

21. A computer program product comprising a computer useable medium having a computer readable program, wherein the computer readable program when executed on a computer causes the computer to:
receive, with a communication device, an input having a predetermined code that initiates a communication through the communication device; and
transmit the predetermined code from the communication device to a telecom carrier device, the telecom carrier device recognizing the predetermined code and routing the communication from the communication device to a dedicated telephone number for a live language interpretation system associated with the predetermined code, the live language interpretation system providing a live language interpretation service through a language interpreter.

22. The computer program product of claim 21, wherein the predetermined code includes a non-numeric character and a numeric character.

23. The computer program product of claim 21, wherein the predetermined code includes a non-alphabetic character and a numeric character.

24. The computer program product of claim 21, wherein the live language interpretation system determines that the communication is from a telecom carrier dedicated number by utilizing Dialed Number Identification Service.

25. A computer program product comprising a computer useable medium having a computer readable program, wherein the computer readable program when executed on a computer causes the computer to:
receive a predetermined code from a communication device;
recognize, with a processor, the predetermined code; and
route the communication from the communication device to a dedicated telephone number for a live language interpretation system associated with the predetermined code, the live language interpretation system providing a live language interpretation service through a language interpreter.

26. The computer program product of claim 25, wherein the predetermined code includes a non-numeric character and a numeric character.

27. The computer program product of claim 25, wherein the predetermined code includes a non-alphabetic character and a numeric character.

28. The computer program product of claim 25, wherein the live language interpretation system determines that the communication is from a telecom carrier dedicated number by utilizing Dialed Number Identification Service.

29. A method comprising:
receiving a predetermined code from a communication device;
recognizing, with a processor, the predetermined code; and
routing the communication from the communication device to a dedicated telephone number for a live language interpretation system associated with the predetermined code, the live language interpretation system providing a live language interpretation service through a language interpreter.

30. The method of claim 29, wherein the predetermined code includes a non-numeric character and a numeric character.

31. The method of claim 29, wherein the predetermined code includes a non-alphabetic character and a numeric character.

32. The method of claim 29, wherein the live language interpretation system determines that the communication is from a telecom carrier dedicated number by utilizing Dialed Number Identification Service.
